(19) United States
(12) Patent Application Publication
(10) Pub. No.: US 2022/0051831 A1
(43) Pub. Date: Feb. 17, 2022

(54) WIRING MEMBER AND WIRING MEMBER ARRANGEMENT STRUCTURE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Yutaka MATSUMURA, Mie (JP)

(21) Appl. No.: 17/278,889

(22) PCT Filed: Aug. 21, 2019
(86) PCT No.: PCT/JP2019/032565

§ 371 Date: Mar. 23, 2021

(30) Foreign Application Priority Data
Oct. 3, 2018 (JP) 2018-188593

(51) Int. Cl. H01B 7/08; H01B 7/40

(52) U.S. Cl. CPC H01B 7/08; B60R 16/0207; H01B 7/40

(57) ABSTRACT

An object is to provide a technique according to which it is possible to restrict a path of a wiring member while reducing the space taken up by the wiring member. A wiring member includes a wiring body and a plurality of linear transmission members. The wiring body is formed flat and includes a plate-like transmission member having a conductor plate formed to be rigid enough to maintain its own shape. The plurality of linear transmission members extend in the same direction as the wiring body and are fixed to the wiring body in a state of being arranged side by side in a width direction of the wiring body on a main surface of the wiring body.

### TECHNICAL FIELD

The present disclosure relates to a wiring member that is arranged in a vehicle.

### BACKGROUND

Patent Document 1 discloses a technique for restricting the path of a wire harness by housing the wire harness inside a protector.

### PRIOR ART DOCUMENT

### Patent Document

Patent Document 1: JP 2013-143868A

### SUMMARY OF THE INVENTION

### Problems to be Solved

However, if a path restriction member such as a protector is separately provided, the space taken up by a wiring member is increased.

In view of this, an object is to provide a technique according to which it is possible to restrict a path of a wiring member while reducing the space taken up by the wiring member.

### Means to Solve the Problem

A wiring member according to the present disclosure is a wiring member including a wiring body that is formed flat and includes a plate-like transmission member having a conductor plate that is formed to be rigid enough to maintain its own shape, and a plurality of linear transmission members that extend in the same direction as the wiring body and are fixed to the wiring body in a state of being arranged side by side in a width direction of the wiring body on a main surface of the wiring body.

### Effect of the Invention

According to the present disclosure, a path of a wiring member can be restricted while reducing the space taken up by the wiring member.

### BRIEF DESCRIPTION OF THE DRAWINGS

FIG. 1 is a perspective view showing a wiring member according to an embodiment.

FIG. 2 is a plan view showing the wiring member according to the embodiment.

FIG. 3 is a transverse cross-sectional view taken along line in FIG. 2.

FIG. 4 is a front view showing an example of a wiring member arrangement structure.

FIG. 5 is a front view showing a variation of the wiring member arrangement structure.

FIG. 6 is a schematic diagram showing an example of the path of the wiring member in the wiring member arrangement structure.

FIG. 7 is a block diagram showing an automobile wiring system to which the wiring member can be applied.

FIG. 8 is a block diagram showing another automobile wiring system to which the wiring member can be applied.

### DETAILED DESCRIPTION TO EXECUTE THE INVENTION

### Description of Embodiments of Disclosure

First, embodiments of the present disclosure will be listed and illustrated.

A wiring member according to the present disclosure and an arrangement structure thereof are described below.

(1) A wiring member includes a wiring body that is formed flat and includes a plate-like transmission member having a conductor plate that is formed to be rigid enough to maintain its own shape, and a plurality of linear transmission members that extend in the same direction as the wiring body and are fixed to the wiring body in a state of being arranged side by side in a width direction of the wiring body on a main surface of the wiring body. Accordingly, due to the other transmission members being fixed in the state of being arranged along the plate-like transmission member that has the conductor plate, the path of the wiring member can be restricted. Further, since the linear transmission members are arranged side by side and overlaid on the flat wiring body, compared to the case where the plurality of linear transmission members are bundled in a round shape, the height of the wiring member can be suppressed and the wiring member can be readily arranged in a relatively narrow space.

(2) The linear transmission members may also bend along the wiring body at a bent portion of the wiring body. With this, due the other transmission members being arranged along the bent portion of the plate-like transmission member that has the conductor plate, the path of the wiring member can be restricted in a bent shape.

(3) A configuration is also possible in which at least one of the wiring body and the linear transmission members includes an insulating coating and a resin layer provided on an outer periphery of the insulating coating, and the wiring body and the linear transmission members are fixed to each other by the resin layer being welded. With this, a member for fixing the wiring body and the linear transmission members to each other can be omitted from the wiring member.

(4) A configuration is also possible in which the wiring body includes a power source line and a ground line that overlap each other, at least one of the power source line and the ground line being the plate-like transmission member, and the linear transmission members are communication lines, and overlap the ground line on the side opposite to the power source line. With this, the ground line functions as a shield that suppresses noise transferred from the power source line to the communication line. With this, another shield member need not be separately provided, and the shield member can be simplified, and thus the wiring member can be reduced in size.

(5) Further, a wiring member arrangement structure according to the present disclosure is a wiring member arrangement structure including the wiring member, and an arrangement target that includes an arrangement surface on which the wiring member is arranged, and, of the wiring body and the linear transmission members, the wiring body is located on the arrangement surface side. With this, even if there is a burr or the like on the arrangement surface, the linear transmission members can be protected by the wiring body.

(6) Further, a wiring member arrangement structure according to the present disclosure is a wiring member arrangement structure including the wiring member, and an arrangement target that includes an arrangement surface on which the wiring member is arranged, and, of the wiring body and the linear transmission members, the linear transmission members are located on the arrangement surface side, and the wiring member arrangement structure further includes a spacer for spacing apart the linear transmission members and the arrangement surface from each other. With this, since the wiring body is located on the outer side, exposure of the linear transmission members can be suppressed, and thus the linear transmission members can be protected from the surrounding members and the like. Further, since the linear transmission members are spaced apart from the arrangement surface by the spacer, even if there is a burr or the like on the arrangement surface, the linear transmission members are unlikely to be damaged.

(7) A configuration is also possible in which a fixing member for fixing the wiring member to the arrangement target is further included, and the fixing member also functions as the spacer. With this, compared to the case where the fixing member and the spacer are separately provided, an increase in the number of components can be suppressed.

(8) A configuration is also possible in which the arrangement surface is a surface that has recesses and protrusions in a first direction in a horizontal direction and extends in a vertical direction and a second direction in the horizontal direction, and the wiring member extends in the second direction in the horizontal direction while bending in the first direction in the horizontal direction in accordance with the recesses and protrusions on the arrangement surface. With this, even in the case where the wiring member extends in the horizontal direction, generation of unnecessary space due to arrangement of the wiring member can be suppressed in the space where the wiring member is arranged.

### Detailed Description of Embodiments of Disclosure

Specific examples of the wiring member and the arrangement structure thereof according to the present disclosure will be described below with reference to the drawings. Note that the present invention is not limited to illustrations of these, but is indicated by the claims, and all changes that come within the meaning and range of equivalency of the claims are intended to be embraced therein.

### Embodiment

Hereinafter, a wiring member and an arrangement structure thereof according to an embodiment will be described.

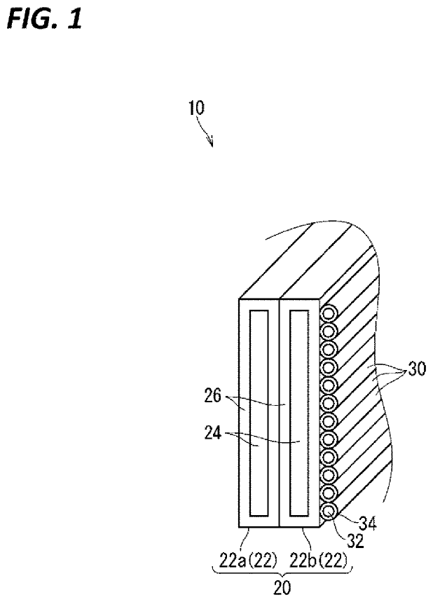

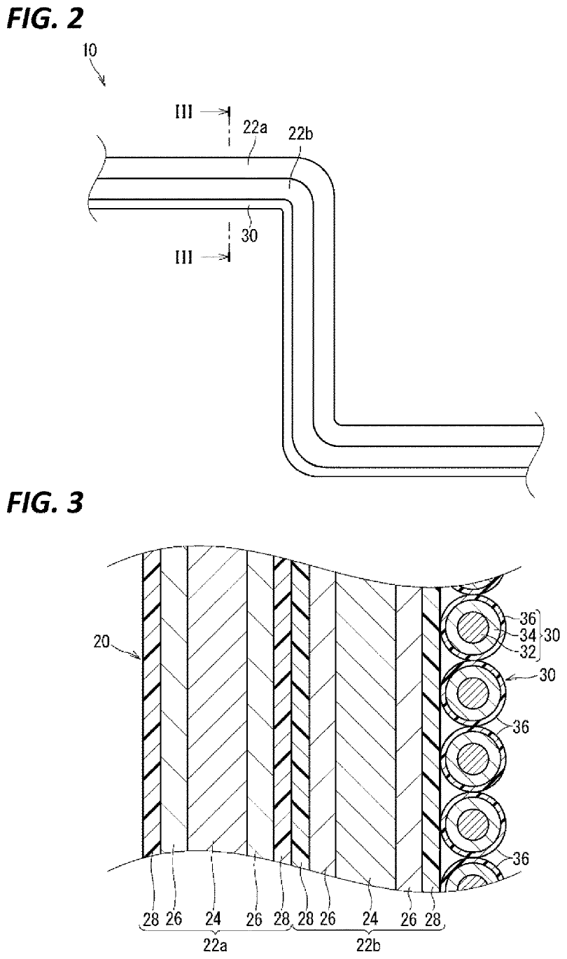

First, the wiring member will be described. FIG. 1 is a perspective view showing a wiring member 10 according to the embodiment. FIG. 2 is a plan view showing the wiring member 10 according to the embodiment. FIG. 3 is a transverse cross-sectional view taken along line in FIG. 2.

The wiring member 10 is provided with a wiring body 20 and a plurality of linear transmission members 30. The wiring member 10 is incorporated in a vehicle and electrically connects various kinds of electrical devices mounted in the vehicle.

The wiring body 20 is formed flat. Here, the wiring body 20 includes a power source line and a ground line. The power source line and the ground line are formed flat, and the wiring body 20 on which the power source line and the ground line are placed is also flat. Here, a plate-like transmission member 22 is used for both the power source line and the ground line. In the example shown in FIG. 1, one plate-like transmission member 22a of the two plate-like transmission members 22 is the power source line, and the other plate-like transmission member 22b is the ground line.

The plate-like transmission members 22 each include a conductor plate 24 and an insulating coating 26 that envelops the conductor plate 24. Here, the plate-like transmission members 22 are arranged in the vehicle and transfer electricity to the electrical devices. The plate-like transmission members 22 can also be considered as plate-like conducting members. The conductor plate 24 is formed into a flat plate by a conductive material such as copper, a copper alloy, aluminum, or an aluminum alloy. The conductor plate 24 is formed to be rigid enough to maintain its own shape. For example, the conductor plate 24 is formed thicker (has a larger cross-sectional area) than a foil so as to be rigid enough to maintain its own shape. For example, a plate having a current value of approximately 400 A, a cross sectional area of 120 mm², a horizontal-to-vertical ratio (ratio between the thickness and the width) of 1:4, and a thickness of 5.48 mm can be adopted as the conductor plate 24. Of course, a plate having another specification can be used as long as the material is rigid enough to maintain its own shape as the conductor plate 24. For example, as the conductor plate 24 having a fine wire size, a plate having a cross sectional area of approximately 15 mm² (a width including a gap portion of approximately 7.7 mm, and a thickness including a gap portion of approximately 2.2 mm) can be adopted. The insulating coating 26 is formed by, for example, an insulating material such as polyvinyl chloride or polyethylene being subjected to extrusion molding on the periphery of the conductor plate 24, or an insulating coating material such as enamel being applied on the periphery of the conductor plate 24. Although two plate-like transmission members 22 are formed by the insulating coatings 26 being separately provided on the conductor plate 24 for the power source line and the conductor plate 24 of the ground line here, one insulating coating 26 may also be collectively provided on the conductor plate 24 for the power source line and the conductor plate 24 for the ground line.

Even so, the wiring body 20 need not necessarily include the power source line and the ground line, and the wiring body 20 may include only the power source line. In this case, a vehicle body ground may be adopted instead of the ground line corresponding to the power source line.

Further, the plate-like transmission members 22 need not necessarily be used for both the power source line and the ground line, and at least one of the transmission members included in the wiring body 20 need only include the plate-like transmission member 22. For example, if the wiring body 20 includes the power source line and the ground line, of the power source line and the ground line, only the power source line or ground line may be the plate-like transmission member 22. In this case, it is conceivable that a flat wire having a core wire that is formed by twisted wires is adopted for the one for which the plate-like transmission member 22 is not used, out of the power source line and the ground line. Preferably, the width of the flat wire is approximately the same as the plate-like transmission member 22. Further, if the wiring body 20 is constituted only by the power source line, for example, the power source line is preferably the plate-like transmission member 22.

The plurality of linear transmission members 30 extend in the same direction as the wiring body 20. The linear transmission members 30 are fixed to the wiring body 20 in a state of being arranged side by side in the width direction of the wiring body 20 on the main surface of the wiring body 20.

Here, general-purpose round wires are used as the linear transmission members 30. Even so, the linear transmission members 30 need only be formed narrower than the plate-like transmission members 22 used for the wiring body 20, and may also be formed by rectangular wires, flat wires, or the like.

The linear transmission members 30 each include a core wire 32 and an insulating coating 34 that envelops the core wire 32. The core wire 32 includes one or more strands. The strands are formed by a conductive material such as copper, a copper alloy, aluminum, or an aluminum alloy. If the core wire 32 includes a plurality of strands, preferably, the strands are twisted. The insulating coating 34 is formed by an insulating material such as polyvinyl chloride or polyethylene being subjected to extrusion molding on the periphery of the core wire 32, or an insulating coating material such as enamel being applied on the periphery of the core wire 32, for example.

The plurality of linear transmission members 30 are communication lines. For example, here, 12 linear transmission members 30, that is, two linear transmission members 30 for each of six systems of the communication buses, are used. The two linear transmission members in one system may be twisted pair wires that have been twisted together or parallel wires that are not twisted together. The six systems are conceivably, a power train system such as engine control, a safety system such as an air bag, a chassis system such as driving control, a body system such as a door lock, a multimedia system such as a car navigation system, and an advanced drive assistance system such as a radar. Of course, the number and applications of the communication buses are not limited to the above, and the number and the applications may be set for each vehicle according to the type or grade of the vehicle, for example. Further, instead of the wires, optical fibers may be adopted as the linear transmission members 30 serving as the communication lines. In other words, the linear transmission members 30 serving as the communication lines need only be members that transfer electrical or optical signals, for example.

Description will be given here on the assumption that communication protocol for performing communication via the communication buses is CAN (Controller Area Network). Of course, the communication protocol need not necessarily be CAN, and any communication protocol such as LIN (Local Interconnect Network) may be used. The communication protocols of the communication buses may also be unified as a single communication protocol, or multiple types of communication protocols may also coexist. In this case, the two linear transmission members 30 need not necessarily be used for one system of the communication bus, and the linear transmission members 30 of the number corresponding to the communication protocol may be adopted.

The 12 linear transmission members 30 are arranged in a row on the main surface of the wiring body 20. Accordingly, the width of the wiring body 20 is at least the total of the widths of the 12 linear transmission members 30. Of course, the linear transmission members 30 may also be arranged in two or more rows on the main surface of the wiring body 20. In this case, the width of the wiring body 20 may be less than the total of the widths of the linear transmission members 30.

The linear transmission members 30 are arranged on the main surface of the ground line with respect to the wiring body 20 formed by the power source line and the ground line overlapping each other. The linear transmission members 30 are overlaid on the ground line on the side opposite to the power source line.

The wiring body 20 and the linear transmission members 30 are fixed to each other by welding here. More specifically, in this example, the plate-like transmission members 22 each include a resin layer 28 on the periphery of the insulating coating 26. Also, the linear transmission members 30 each include a resin layer 36 on the periphery of the insulating coating 34. The plate-like transmission member 22 and the linear transmission members 30 are fixed to each other by the resin layers 28 and 36 melting and adhering to each other.

Note that, here, the plate-like transmission members 22 that overlap each other are also fixed to each other by the resin layers 28 melting and adhering to each other. Further, the adjacent linear transmission members 30 are fixed to each other by the resin layers 36 melting and adhering to each other.

However, even in the case where the members are fixed by welding, both the plate-like transmission member 22 and the linear transmission members 30 need not include the resin layers 28 and 36, respectively, and only the plate-like transmission member 22 may include the resin layer 28 or, alternatively, only the linear transmission members 30 may include the resin layer 36. In other words, it suffices that a resin layer is formed on at least one of a surface of the wiring body 20 that comes into contact with the linear transmission members 30 and a surface of the linear transmission members 30 that comes into contact with the wiring body 20, and by this resin layer melting and adhering to the other member, the wiring body 20 and the linear transmission members 30 are fixed to each other.

When such a welded state is to be created, the welding method is not particularly limited, and any welding method such as ultrasonic welding or heating and pressurizing welding may be adopted.

The linear transmission members 30 bend along with the wiring body 20 at the portion where the wiring body 20 bends. More specifically, the wiring body 20 bends in the front-back direction thereof. The linear transmission members 30, which are arranged at the portion of the wiring body 20 that bends in the front-back direction, bend in the same direction as the wiring body 20. At this time, the wiring body 20 is maintained in the bent shape due to the rigidity of the conductor plate 24. The linear transmission members 30 are maintained in the bent shape by being fixed to the wiring body 20. Accordingly, the wiring member 10 is maintained in the bent shape.

Here, when the wiring body 20 is formed in the bent shape, the wiring body 20 may be bent after being molded in a linear shape, for example, or the wiring body 20 may be molded in the bent shape. If the wiring body 20 is bent after once being molded in a linear shape, for example, when the linear transmission members 30 are also formed in the bent shape, the wiring body 20 and the linear transmission members 30, which extend linearly, may be bent in the state of being fixed to each other. In this case, the work efficiency can be improved. Preferably, in this case, the linear transmission members 30 are resistant to stretching. With this, even if the linear transmission members 30 and the wiring body 20 are bent together, the core wires 32 of the linear transmission members 30 are not likely to break.

Further, in the state where the wiring body 20 has the bent shape due to being bent after being molded in a linear shape, or being molded into the bent shape, the linear transmission members 30 may be bent so as to conform to the bent portion of the wiring body 20, and thereafter, the wiring body 20 and the linear transmission members 30 may be fixed to each other. In this case, it is possible to suppress a case where the bending curvature of the linear transmission members 30 is smaller than the minimum bending curvature, a case where the linear transmission members 30 are excessively stretched due to being bent, and the like.

According to the wiring member 10 configured as above, by the other transmission members being fixed to the plate-like transmission member 22 having the conductor plate 24 in the state of being arranged along the plate-like transmission member 22, the path of the wiring member 10 can be restricted. Further, since the linear transmission members 30 are arranged side by side and overlaid on the flat wiring body 20, compared to the case where multiple linear transmission members 30 are bundled in a round shape, the wiring members 10 can be suppressed in height, and readily arranged even in a relatively narrow space.

Further, due to the other transmission members being fixed to the bent portion of the plate-like transmission member 22 that includes the conductor plate 24 in the state of being arranged along the bent portion, the wiring members 10 can be restricted in the bent shape.

Further, since the wiring body 20 and the linear transmission members 30 are fixed to each other by welding of the resin layers 28 and 36 provided on the outer peripheries of the insulating coatings 26 and 34 respectively, the member for fixing the wiring body 20 and the linear transmission members 30 to each other can be omitted from the wiring member 10.

Further, in the wiring body 20, since the power source line, the ground line, and the communication lines overlap in this order, the ground line functions as a shield that suppresses the noise that is transferred from the power source line to the communication lines. With this, another shield member need not be separately provided, and the shield member can be simplified, and thus the wiring member 10 can be reduced in size.

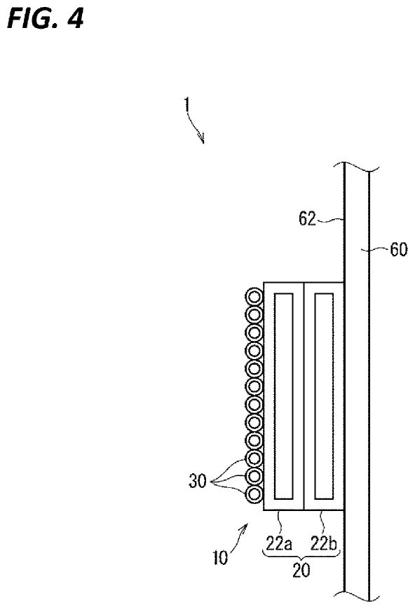

Next, a wiring member arrangement structure will be illustrated. FIG. 4 is a front view showing an example of a wiring member arrangement structure 1.

The wiring member arrangement structure 1 is provided with the above wiring member 10 and an arrangement target on which the wiring member 10 is arranged.

The arrangement target includes an arrangement surface on which the wiring member 10 is arranged. The arrangement target is, for example, a panel 60 of a vehicle 80. In this case, the arrangement surface is a main surface 62 of the panel.

In the example shown in FIG. 4, the panel 60 is provided standing upright in the vertical direction such that the main surface 62 faces in the horizontal direction. The wiring member 10 is arranged such that the width direction of the plate-like transmission member 22 is aligned with the vertical direction. Of course, the panel 60 may also be provided extending in the horizontal direction such that the main surface 62 faces the vertical direction. In this case, the wiring member 10 may also be arranged such that the width direction of the plate-like transmission member 22 is aligned with the horizontal direction. This holds true in the following examples as well.

In this wiring member arrangement structure 1, of the wiring member 20 and the linear transmission members 30, the wiring body 20 is located on the main surface (arrangement surface) 62 side.

According to the wiring member arrangement structure 1 configured as above, due the wiring member 20 out of the wiring body 20 and the linear transmission members 30 being located on the main surface 62 side, even if there is a burr or the like on the main surface 62, the linear transmission members 30 can be protected by the wiring body 20.

Note that although the wiring member 10 is in contact with the main surface 62 in the example shown in FIG. 4, such a structure is not necessarily required. The wiring member 10 may also be arranged not in contact with the arrangement surface. That is, the wiring member 10 may also be arranged in a state of being spaced apart from the arrangement surface. When attempting to prevent the wiring member 10 from interfering with the arrangement target, for example, it is conceivable that the wiring member 10 and the arrangement surface are arranged not in contact with each other. Even in such a case where the wiring member 10 is arranged spaced apart from the arrangement surface, the path of the spaced-apart portion can be restricted due to the rigidity of the plate-like transmission member 22, and can extend while avoiding interference with the surrounding members. In particular, in the vehicle engine room, the members that can be arranged along the wiring member 10 are limited, and thus the wiring member 10 cannot always be arranged along the other members. Even in this case, since the wiring member 10 can maintain its own path, it is possible to prevent the wiring member 10 from interfering with the surrounding members.

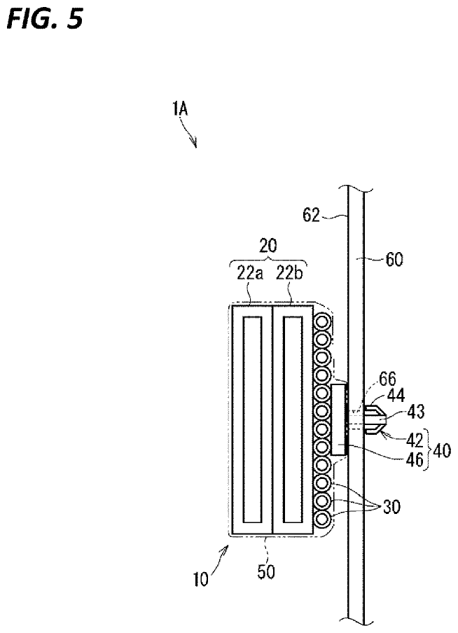

FIG. 5 is a front view showing a variation of the wiring member arrangement structure 1.

In the wiring member arrangement structure 1A according to the variation, of the wiring body 20 and the linear transmission members 30, the linear transmission members 30 are located on the main surface 62 side.

At this time, the wiring member arrangement structure 1A further includes a spacer that spaces the linear transmission members 30 apart from the main surface 62. This wiring member arrangement structure 1A further includes a fixing member for fixing the wiring member 10 to the panel 60. This fixing member also functions as the spacer. In the example shown in FIG. 5, a sleeve-shaped clamp 40 is used as a spacer-cum-fixing member. The sleeve-shaped clamp 40 includes a locking portion 42 that locks to the fixing target and a sleeve portion 46 that is fixed to the wiring member 10.

The locking portion 42 is formed so as to be capable of being inserted into and locking to a through hole formed in the fixing target. Specifically, the locking portion 42 includes a columnar portion 43 and locking pieces 44 provided at a leading end of the columnar portion 43. The locking portion 42 can pass through the through hole by the locking pieces 44 elastically deforming to retract when being inserted into the through hole. The locking portion 42 can be locked in the peripheral edge portion of the through hole by the locking pieces 44 elastically returning after passing through the through hole.

The sleeve portion 46 is provided at a base end portion of the columnar portion 43. The sleeve portion 46 is formed into a plate shape. The sleeve portion 46 is provided on the wiring member 10. The sleeve portion 46 is fixed to the wiring member 10 by wrapping a binding member 50 such as adhesive tape or a cable tie around the sleeve portion 46 and the wiring member 10, and thereby the sleeve-shaped clamp 40 is fixed to the wiring member 10. Note that the sleeve-shaped clamp 40 may be a single-sleeve clamp in which the sleeve portion 46 extends in one direction with respect to the locking portion 42, or a double-sleeve clamp in which the sleeve portions 46 extend in two directions with respect to the locking portion 42.

Here, the sleeve-shaped clamp 40 is fixed to the wiring member 10 by the binding member 50 wrapping around the sleeve portion 46 and the wiring member 10 in the state where the sleeve portion 46 is placed on the linear transmission members 30. The locking portion 42 provided standing upright from the sleeve portion 46 is inserted and locked into the through hole 66 formed in the panel 60. With these, the wiring member 10 is fixed to the panel 60. At this time, the sleeve portion 46 is interposed between the main surface 62 of the panel 60 and the wiring member 10 to function as the spacer.

According to the wiring member arrangement structure 1A configured as above, since the wiring body 20 is located on the outer side with respect to the linear transmission members 30, exposure of the linear transmission members 30 can be suppressed, and thus the linear transmission members 30 can be protected from the surrounding members and the like. Further, since the linear transmission members 30 are spaced apart from the main surface 62 by the spacer, even if there is a burr or the like on the main surface 62, the linear transmission members 30 are unlikely to be damaged.

Further, since the fixing member also functions as the spacer, compared to a case where the fixing member and the spacer are separately provided, an increase in the number of components can be suppressed. Even so, the fixing member and the spacer may also be separately provided. Note that a member other than the sleeve-shaped clamp 40, such as a band clamp, may also be provided as the fixing member.

Note that if the spacer or the spacer-cum-fixing member is fixed to the wiring member 10, the spacer or the spacer-cum-fixing member can also be considered as one element included in the wiring member 10.

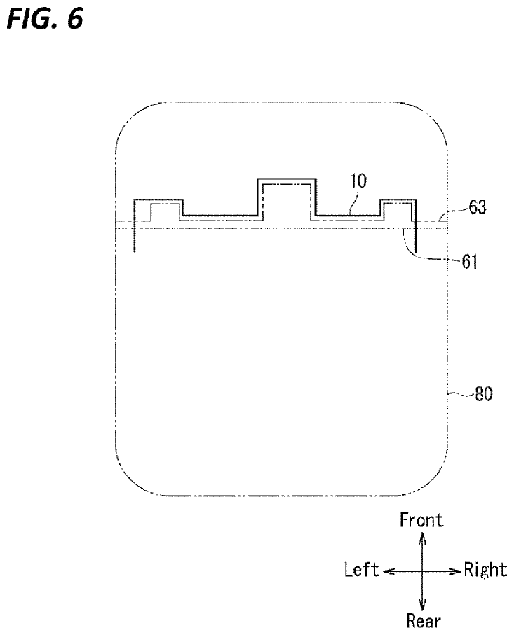

FIG. 6 is a schematic diagram showing an example of a path of the wiring member 10 in the wiring member arrangement structures 1 and 1A.

In the example shown in FIG. 6, the wiring member 10 is arranged along the main surface 63 on an engine room side of a dash panel 61 of the vehicle 80. Accordingly, in the example shown in FIG. 6, the dash panel 61 is the arrangement target, and the main surface 63 on the engine room side of the dash panel 61 is the arrangement surface.

At this time, the main surface 63 on the engine room side of the dash panel 61 has recesses and protrusions in the front-rear direction of the vehicle 80 and extends in the vertical direction and the width direction of the vehicle 80. The wiring member 10 extends in the width direction of the vehicle 80 while bending in the front-rear direction of the vehicle 80 in accordance with the recesses and protrusions of the main surface 63 on the engine room side of the dash panel 61.

In this manner, a first direction and a second direction in the horizontal direction intersect each other. It is conceivable that the arrangement surface on which the wiring member 10 is arranged is a surface that has recesses and protrusions in a first direction in the horizontal direction and extends in the vertical direction and in a second direction in the horizontal direction, and the wiring member 10 extends in the second direction in the horizontal direction while bending in the first direction in the horizontal direction in accordance with the recesses and protrusions of the arrangement surface.

Even in the case where the wiring member 10 extends in the horizontal direction as above, generation of unnecessary space due to arrangement of the wiring member 10 can be suppressed in the space in which the wiring member 10 is arranged. More specifically, with respect to the main surface 63 on the engine room side of the dash panel 61, when the wiring member 10 is arranged so as to extend straight in the width direction of the vehicle 80, unnecessary space may be generated between the recessed portions in the main surface 63 on the engine room side of the dash panel 61 and the wiring member 10. In view of this, in the case where the wiring member 10 extends in the width direction of the vehicle 80 while bending in the front-rear direction of the vehicle 80 in accordance with the recesses and protrusions of the main surface 63 on the engine room side of the dash panel 61 as shown in FIG. 6, unnecessary space is unlikely to be generated between the recessed portions in the main surface 63 on the engine room side of the dash panel 61 and the wiring member 10.

### Variation

Although in the above description, the wiring body 20 and the linear transmission members 30 in the wiring member 10 are fixed to each other by welding, such a configuration is not necessarily required. The wiring body 20 and the linear transmission members 30 may be fixed by any fixing means. For example, the wiring body 20 and the linear transmission members 30 may also be fixed by being wrapped with a binding member 50 such as adhesive tape or a cable tie. Alternatively, the wiring body 20 and the linear transmission members 30 may also be fixed to each other by an adhesive agent or double-sided adhesive tape provided therebetween, for example.

Although in the above description, in the wiring member 10, the linear transmission members 30 are maintained in the state of being arranged side by side by the fixing means for fixing the wiring body 20 and the linear transmission members 30 to each other, such a configuration is not necessarily required. A means for maintaining the linear transmission members 30 in the state of being arranged side by side may also be provided separately from the fixing means for fixing the wiring body 20 and the linear transmission members 30 to each other. For example, the linear transmission members 30 may also be arranged side by side on a sheet member and fixed to the sheet member. Further, the sheet member may also be fixed to the wiring body 20 by the fixing means as described above as the fixing means for fixing the wiring body 20 and the linear transmission members 30 to each other.

Further, although in the above description, the plate-like transmission members 22 that overlap each other are also fixed by the resin layers 28 melting and adhering to each other, such a configuration is not necessarily required. The plate-like transmission members 22 need not necessarily be fixed to each other by the resin layers 28 melting and adhering to each other. In this case, the plate-like transmission members 22 may be fixed to each other by another fixing means as described above as the fixing means for fixing the wiring body 20 and the linear transmission members 30 to each other.

Further, although in the above description, the adjacent linear transmission members 30 are also fixed by the resin layers 36 melting and adhering to each other, such a configuration is not necessarily required. The linear transmission members 30 need not necessarily be fixed to each other by the resin layers 36 melting and adhering to each other. In this case, the linear transmission members 30 may be fixed by another fixing means as described above as the fixing means for fixing the wiring body 20 and the linear transmission members 30 to each other. Further, the linear transmission members 30 need not be necessarily fixed to each other and may be arranged spaced apart from each other.

### Application Example of Wiring Member

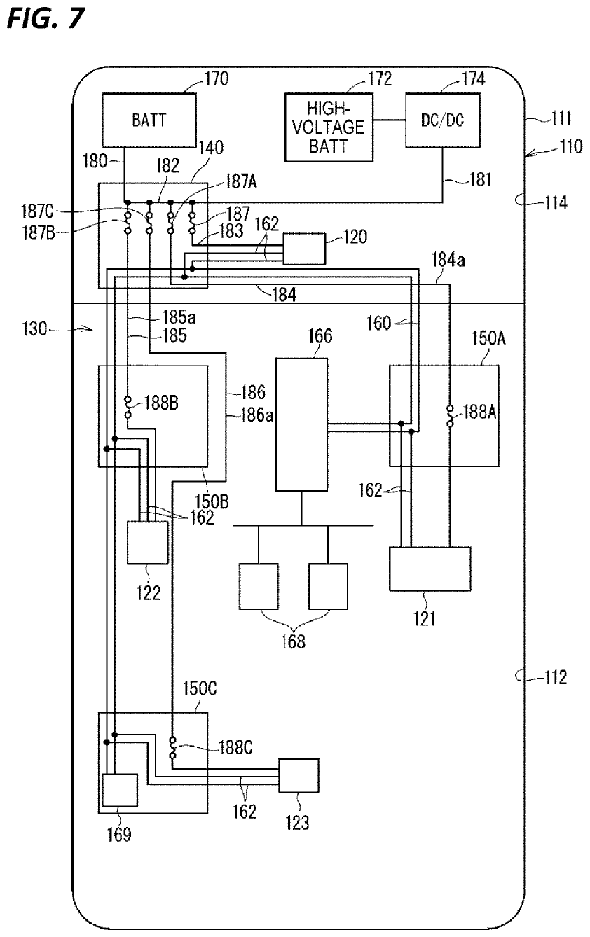

FIG. 7 is a block diagram showing an automobile wiring system 130 to which the wiring member 10 can be applied.

The automobile wiring system 130 is mounted in an automobile 110 in which a plurality of electrical components 120, 121, 122, and 123 are incorporated. Here, a space inside a body 111 of the automobile 110 is divided into a vehicle cabin 112 and a front chamber 114. The vehicle cabin 112 is a space for accommodating occupants and baggage. The front chamber 114 is a space located in front of the vehicle cabin 112. If the automobile 110 is driven by an internal combustion engine, the front chamber 114 is an engine room. If the automobile 110 is driven by an electric motor, the front chamber 114 is a motor room. If the automobile 110 is driven by an internal combustion engine and an electric motor, the front chamber 114 is an engine and motor room.

The electrical components 120, 121, 122, and 123 are actuators for a sensor, a switch, a motor, and the like, a lighting device, a heater, an ECU (Electrical Control Unit), and the like. The electrical components 120, 121, 122, and 123 are arranged dispersed in various portions of the automobile. In the following description, it is assumed that the electrical component 120 is arranged in the front chamber 114, the electrical component 121 is arranged on the front-right side in the vehicle cabin 112, the electrical component 122 is arranged on the front-left side in the vehicle cabin 112, and the electrical component 123 is arranged on the rear side in the vehicle cabin 112.

The automobile wiring system 130 includes a first connection device 140 and a plurality of second connection devices 150A, 150B, and 150C.

The first connection device 140 is connected to the electrical component 120 such that the first connection device 140 can communicate with and supply power to the electrical component 120. Here, the first connection device 140 is arranged in the front chamber 114, and mainly connected to the electrical component 120 arranged in the front chamber 114 such that the first connection device 140 can communicate with and supply power to the electrical component 120.

The plurality of second connection devices 150A, 150B, and 150C are connected to the electrical components 121, 122, and 123 such that the second connection devices 150A, 150B, and 150C can communicate with and supply power to the electrical components 121, 122, and 123. Here, the plurality of second connection devices 150A, 150B, and 150C are arranged in the vehicle cabin 112, and mainly connected to the electrical components 121, 122, and 123 arranged in the vehicle cabin 112 such that the second connection devices 150A, 150B, and 150C can communicate with and supply power to the electrical components 121, 122, and 123.

More specifically, the second connection device 150A is arranged on the front-right side in the vehicle cabin 112 and is mainly connected to the electrical component 121 arranged on the front-right side in the vehicle cabin 112 such that the second connection device 150A can communicate with and supply power to the electrical component 121 arranged on the front-right side in the vehicle cabin 112. The second connection device 150B is arranged on the front-left side in the vehicle cabin 112 and is mainly connected to the electrical component 122 arranged on the front-left side in the vehicle cabin 112 such that the second connection device 150B can communicate with and supply power to the electrical component 122 arranged on the front-left side in the vehicle cabin 112. The second connection device 150C is arranged on the rear side in the vehicle cabin 112 and is mainly connected to the electrical component 123 arranged on the rear side in the vehicle cabin 112 such that the second connection device 150C can communicate with and supply power to the electrical component 123 arranged on the rear side in the vehicle cabin 112.

That is, the automobile 110 is divided into a plurality of areas, and the first connection device 140 and the plurality of second connection devices 150A, 150B, and 150C are respectively arranged in the areas. The electrical components 120, 121, 122, and 123 in the areas are connected to the first connection device 140 and the second connection devices 150A, 150B, and 150C arranged in the respective areas.

The automobile wiring system 130 includes a bus communication line 160 for performing mutual communication with the first connection device 140 and the second connection devices 150A, 150B, and 150C. The bus communication line 160 is provided sequentially passing through the first connection device 140, and the second connection devices 150A, 150B, and 150C. In other words, the first connection device 140 and the second connection devices 150A, 150B, and 150C are connected in a row through the bus communication line 160. More specifically, the bus communication line 160 is a communication line for transferring signals compliant with a multiplex communication protocol such as CAN or LIN, and constituted by twisted pair wires, for example. The bus communication line 160 is arranged so as to pass through from one of the first connection device 140 and the second connection devices 150A, 150B, and 150C, to another one via the remaining devices. For this reason, as a whole, the first connection device 140 and the second connection devices 150A, 150B, and 150C are connected to each other through the one bus communication line 160 so as to be capable of communicating with each other. Here, the bus communication line 160 is arranged so as to pass through from the second connection device 150A to the second connection device 150C, via the first connection device 140 and the second connection device 150B.

In the automobile wiring system 130, if a plurality of multiplex communication protocols are adopted, the automobile wiring 130 may also include a plurality of the bus communication lines 160 as described above in accordance with the multiplex communication protocols.

The bus communication line 160 is branched at the first connection device 140 and the second connection devices 150A, 150B, and 150C so as to be capable of communicating with the electrical components 120, 121, 122, and 123, respectively. Here, the bus communication line 160 is branched at the first connection device 140 and the second connection devices 150A, 150B, and 150C, and the branched lines 162 are guided out from the first connection device 140 and the second connection devices 150A, 150B, and 150C to the outside and connected to the electrical components 120, 121, 122, and 123, respectively. For this reason, the electrical components 120, 121, 122, and 123 are bus-connected to the bus communication line 160 at any one of the first connection device 140 and the second connection devices 150A, 150B, and 150C. Since the bus communication line 160 is a communication line for transferring signals compliant with the multiplex communication protocol, the electrical components 120, 121, 122, and 123 are connected to each other via the bus communication line 160 so as to be capable of communicating with each other.

A gateway device 166 is connected to the bus communication line 160. Other electrical components 168 that communicate according to another communication protocol can be connected to the bus communication line 160 through the gateway device 166. The other electrical components 168 connected to the gateway device 166 conceivably include components such as a display device and a switch that are provided on an instrument panel.

Here, the gateway device 166 is connected to one end portion on the second connection device 150A side of the bus communication line 160, and also functions as a terminating resistor. Since the gateway device 166 is connected to the one end of the bus communication line 160, when changing the other electrical component, such a task can be easily dealt with by changing the connection configuration between the gateway device 166 on the one end side of the bus communication line 160 and the electrical component 168, without changing the wiring between the connected devices of the bus communication line 160.

Further, another end portion on the second connection device 150C side of the bus communication line 160 is connected to a terminating resistor 169. The terminating resistor 169 may be provided inside or outside the second connection device 150C.

A plurality of power sources 170 and 172 are provided in the automobile 110. Here, it is assumed that the automobile 110 is an electric car, and two batteries 170 and 172 having different voltages are mounted therein as the plurality of power sources 170 and 172. The voltage of the battery 170 is lower than the voltage of the battery 172. The battery 170 is a low-voltage battery which is also called an auxiliary battery, and supplies a voltage of 5 to 59 V, for example. The battery 172 is a power source that supplies a voltage suitable for driving the electric motor for driving the automobile 110, and is a high-voltage battery which supplies a voltage of 90 to 500 V, for example.

The batteries 170 and 172 are connected to and aggregated at the first connection device 140. Preferably, all the power sources mounted in the automobile 110 are connected to the first connection device 140.

The battery 170 is directly connected to the first connection device 140 in order to supply a low voltage. The battery 170 is connected to the first connection device 140 via a wire and a connector, for example.

The battery 172 is connected to the first connection device 140 via a DC-DC converter 174. The DC-DC converter 174 converts a high-voltage of the battery 172 into a low voltage of 5 to 59 V in accordance with the voltage of the battery 170. The battery 172 is connected to the first connection device 140 via a wire and a connector, for example.

A power source line 180 from the battery 170 and a power source line 181 from the battery 172 that passes through the DC-DC converter 174 are connected to a common power source line 182 in the first connection device 140 and aggregated into one line. Since these power source lines 180 and 181 do not need be arranged along other communication lines in particular and can be wired on their own, the power source lines 180 and 181 can be easily arranged on paths located away from the driver's seat, the passenger's seat, and the like.

The power from the batteries 170 and 172 is distributed from the first connection device 140 to the second connection devices 150A, 150B, and 150C.

That is, in the first connection device 140, the common power source line 182 is branched into the power source lines used for the first connection device 140, the second connection devices 150A, 150B, and 150C. In this example, the common power source line 182 is branched into four branched power source lines 183, 184, 185, and 186.

The branched power source line 183 is guided out from the first connection device 140 to the outside and connected to the electrical component 120 that is connected to the first connection device 140. In this manner, the electrical component 120 is supplied with power. The branched power source line 183 may also be directly guided out from the first connection device 140 to the outside and connected to the electrical component 120. The branched power source line 183 may also be divided into a wiring portion inside the first connection device 140 and a wiring portion that is on the outside of the first connection device 140 and connected to the electrical component 120, and the two wiring portions may be connected by a connector.

The branched power source line 184 is guided out from the first connection device 140 to the outside and introduced into the second connection device 150A via the space in the automobile 110. The branched power source line 184 is guided out from the inside of the second connection device 150A to the outside, and is connected to the electrical component 121 that is connected to the second connection device 150A. In this manner, the electrical component 121 is supplied with power. In the case where a plurality of the electrical components 121 are connected to the second connection device 150A, the branched power source line 184 is branched inside the second connection device 150A, and thereafter the resultant lines are guided to the outside of the second connection device 150A, and are respectively connected to the electrical components 121. In this manner, the plurality of electrical components 121 connected to the second connection device 150A are supplied with power.

The branched power source line 184 may be constituted by a continuous conductive path. The branched power source line 184 may also be constituted by being divided into a wiring portion inside the first connection device 140, a wiring portion inside the second connection device 150A, and a wiring portion laid therebetween in the automobile, and connecting the three wiring portions by connectors.

The branched power source lines 185 and 186 are guided out from the first connection device 140 to the outside and introduced into the second connection devices 150B and 150C via the space in the automobile 110. Similarly to the configuration of the branched power source line 184 in the second connection device 150A, the branched power source lines 185 and 186 are connected to the electrical components 122 and 123 that are connected to the second connection devices 150B and 150C, respectively.

Note that in the case where any one of the electrical component 120 connected to the first connection device 140 and the electrical components 121, 122, and 123 connected to the second connection devices 150A, 150B, and 150C is driven at a voltage that is different from the voltage of the battery 170 (or a voltage converted by the DC-DC converter 174), a configuration is also possible in which a converter is incorporated in the first connection device 140 and the converted voltage is supplied via any one of the branched power source lines 183, 184, 185, and 186.

When portions of the branched power source lines 184, 185, and 186 that are provided between the first connection device 140 and the plurality of second connection devices 150A, 150B, and 150C are power source wiring portions 184a, 185a, and 186a, the plurality of power source wiring portions 184a, 185a, and 186a may differ in conductor cross-sectional area (area of the cross section perpendicular to the extending direction). Here, the power source wiring portions 184a, 185a, and 186a are formed to have different conductor cross-sectional areas from each other. The conductor cross-sectional areas of the power source wiring portions 184a, 185a, and 186a are set in accordance with currents flowing through the electrical components 121, 122, and 123 that are connected to the second connection devices 150A, 150B, and 150C respectively. The conductor cross-sectional areas of the power source wiring portions 184a, 185a, and 186a are smaller than the conductor cross-sectional areas of the power source lines 180 and 181 that connect the first connection device 140 and the batteries 170 and 172.

The first connection device 140 is provided with overcurrent interrupting portions 187A, 187B, and 187C corresponding to the second connection devices 150A, 150B, and 150C respectively. The overcurrent interrupting portions 187A, 187B, and 187C interrupt power source lines when an excessive current flows therethrough. Here, in the first connection device 140, the overcurrent interrupting portion 187A is interposed in the branched power source line 184, the overcurrent interrupting portion 187B is interposed in the branched power source line 185, and the overcurrent interrupting portion 187C is interposed in the branched power source line 186.

The first connection device 140 is provided with an overcurrent interrupting portion 187 corresponding to the electrical component 120 connected to the first connection device 140. The overcurrent interrupting portion 187 is interposed in the branched power source line 183.

It is assumed that the overcurrent interrupting portions 187, 187A, 187B, and 187C are fuses. The overcurrent interrupting portions 187, 187A, 187B, and 187C may each be constituted by a combination of a current sensor and a semiconductor switch for which switching on/off is controlled based on the output of the current sensor.

Here, the second connection devices 150A, 150B, and 150C are also provided with overcurrent interrupting portions 188A, 188B, and 188C respectively.

Note that ground connection in the automobile wiring system 130 may be performed via the vehicle body, or performed by arranging ground wires along the above branched power source lines 184, 185, and 186.

According to the automobile wiring system 130 configured as above, even in the case where the power source system mounted in the automobile 110 is different, most of the automobile wiring system 130 can be re-used without changing the design by changing the configuration that connects the first connection device 140 and the plurality of power sources. For example, it is assumed that a low-voltage battery and an alternator are mounted as the plurality of power sources. In this case, by changing the configuration such that the low-voltage battery and the alternator are connected to the first connection device, most of the automobile wiring system 130 can be re-used without changing the design.

Further, the bus communication line 160 sequentially passes through the first connection device 140 and the second connection devices 150A, 150B, and 150C, and is branched at the first connection device 140 and the plurality of second connection devices 150A, 150B, and 150C so as to be able to communicate with the electrical components 120, 121, 122, and 123 respectively. For this reason, if there is any change in the electrical components 120, 121, 122, and 123 connected to the first connection device 140 and the second connection devices, such a change can be easily dealt with. For example, when connecting an additional electrical component to the second connection device 150A, the electrical component to be added need only be connected to the bus communication line 160 and the power source line at the second connection device 150A.

As described above, in the case where the power source system is different or the electrical component to be connected is different, for example, such a change can be easily dealt with by designing such that as much of the automobile wiring system 130 as possible is re-used, and the versatility of the automobile wiring system 130 can be improved as much as possible.

Further, the automobile 110 is divided into the plurality of areas, the power source is distributed from the first connection device 140 to the second connection devices 150A, 150B, and 150C in the areas, and the electrical components 121, 122, and 123 are connected to the first connection device 140, and the second connection devices 150A, 150B, and 150C in the respective areas so as to be capable of communicating with each other in multiplex communication. For this reason, in many cases, it suffices that the electrical design change in the automobile 110 is considered on an area unit basis.

In the above automobile wiring system 130, the wiring member 10 can be applied to the bus communication line 160 and the common power source line 182 laid between the first connection device 140 and the second connection device 150A and in the front chamber 114.

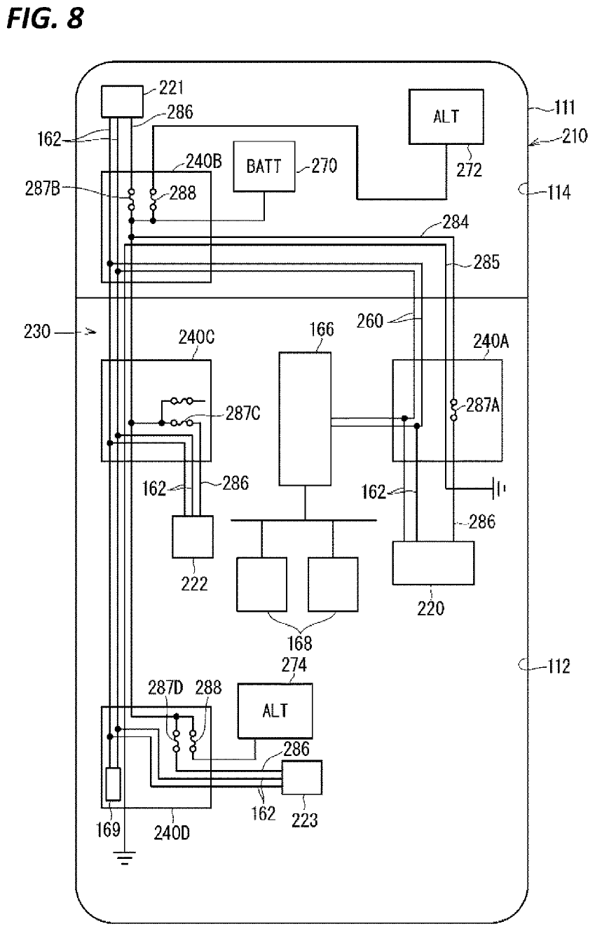

FIG. 8 is a block diagram showing another automobile wiring system 230 to which the wiring member 10 can be applied.

The following description focuses on the difference between the configuration of the automobile wiring system 230 and that of the automobile wiring system 130. The second connection device 150A, the first connection device 140, and the second connection devices 150B and 150C in the automobile wiring system 130 respectively correspond to a plurality of connection devices 240A, 240B, 240C, and 240D in the automobile wiring system 230, and electrical components 220, 221, 222, and 223 are respectively connected thereto. The bus communication line 160 corresponds to a bus communication line 260.

Further, instead of branching the common power source line 182 into the four branched power source lines 183, 184, 185, and 186, a power supply line 284 is provided sequentially passing through a plurality of connection devices 240A, 240B, 240C, and 240D. In other words, the plurality of connection devices 240A, 240B, 240C, and 240D are connected in a row through the power supply line 284. Here, a ground line 285 is arranged along the power supply line 284. Although the ground line 285 is connected to the vehicle body ground here, the ground line 285 may also be connected to a battery 270, alternators 272 and 274, and the like.

The battery 270 and the alternator 272 are connected to the power supply line 284 at the connection device 240B. The alternator 274 is connected to the power supply line 284 at the connection device 240D. That is, since the power supply line 284 is provided sequentially passing through the connection devices 240A, 240B, 240C, and 240D, any of the connection devices 240A, 240B, 240C, and 240D can be supplied with power from the power source through the power supply line 284.

The power supply line 284 is branched at the connection devices 240A, 240B, 240C, and 240D so as to be capable of supplying power to the electrical components 220, 221, 222, and 223, respectively. Here, the power supply line 284 is branched at the connection devices 240A, 240B, 240C, and 240D, and the branched power source lines 286 are guided out from the connection devices 240A, 240B, 240C, and 240D to the outside, and connected to the electrical components 220, 221, 222, and 223, respectively.

Further, overcurrent interrupting portions 287A, 287B, 287C, and 287D are provided in the connection devices 240A, 240B, 240C, and 240D, respectively. The overcurrent interrupting portions 287A, 287B, 287C, and 287D are interposed in the branched power source lines 286 that branch from the power supply line 284 into the electrical components 220, 221, 222, and 223, and interrupt the power supply lines when an excessive current flows therethrough. Accordingly, in the connection devices 240A, 240B, 240C, and 240D, a power source lines can be interrupted at an appropriate overcurrent corresponding to the electrical components 220, 221, 222, and 223 that are respectively connected to the connection devices 240A, 240B, 240C, and 240D.

Further, in the connection devices 240B and 240D, an overcurrent interrupting portion 288 is also interposed between the alternator 272 and the power supply line 284, and between the alternator 274 and the power supply line 284. It is assumed that the overcurrent interrupting portions 287A, 287B, 287C, 287D, and 288 are fuses.

According to this example, even in the case where the power source system mounted in the automobile 210 is different, most of the automobile wiring system 230 can be re-used without changing the design by changing the configuration that connects the plurality of connection devices 240A, 240B, 240C, and 240D and the plurality of power sources. The bus communication line 260 sequentially passes through the connection devices 240A, 240B, 240C, and 240D, and branched at the connection devices 240A, 240B, 240C, and 240D so as to be communicable with the electrical components 220, 221, 222, and 223, respectively. For this reason, if there is any change in the electrical components 220, 221, 222, and 223 connected to the connection devices 240A, 240B, 240C, and 240D, such a change can be easily dealt with. For this reason, in the case where the power source system is different or the electrical component to be connected is different, for example, such a change can be easily dealt with by re-using as much of the automobile wiring system 230 as possible, and the versatility of the automobile wiring system 230 can be improved as much as possible.

Further, similarly to the above, in many cases, it suffices that an electrical design change in the automobile 210 is considered on the area unit basis.

In the above automobile wiring system 230, the wiring member 10 can be applied to the bus communication line 260 and the power supply line 284 laid between the connection device 240A and the connection device 240B and in the front chamber 114. Further, the wiring member 10 can also be applied to the bus communication line 260 and the power supply line 284 that extends from the connection device 240A to the connection device 240D via the connection devices 240B and 240C.

Note that the configurations illustrated in the above embodiment and the variations can be combined as appropriate as long as no contradiction arises.

### LIST OF REFERENCE NUMERALS

1 Wiring member arrangement structure
10 Wiring member
20 Wiring body
22 Plate-like transmission member
24 Conductor plate
26 Insulating coating
28 Resin layer
30 Linear transmission members
32 Core wire
34 Insulating coating
36 Resin layer
40 Sleeve-shaped clamp (spacer-cum-fixing member)
42 Locking portion
46 Sleeve portion (spacer)
50 Binding member
60 Panel (arrangement target)
61 Dash panel (arrangement target)
62 Main surface (arrangement surface) of panel
63 Main surface (arrangement surface) on engine room of dash panel
80 Vehicle

1. A wiring member comprising:
a wiring body that includes a plurality of plate-like transmission members having a conductor plate that is formed to be rigid enough to maintain its own shape, the wiring body being formed flat while the plurality of plate-like transmission members are overlaid thereon in a thickness direction; and
a plurality of linear transmission members that extend in the same direction as the wiring body and are fixed to the wiring body in a state of being arranged side by side in a width direction of the wiring body on a main surface of the wiring body.

2. The wiring member according to claim 1,
wherein the linear transmission members bend along the wiring body at a bent portion of the wiring body.

3. The wiring member according to claim 2,
wherein the linear transmission members are maintained in the bent shape by being fixed to the wiring body.

4. The wiring member according to claim 1,
wherein at least one of the wiring body and the linear transmission members includes an insulating coating and a resin layer provided on an outer periphery of the insulating coating, and
the wiring body and the linear transmission members are fixed to each other by the resin layer being welded.

5. The wiring member according to claim 1,
wherein the wiring body includes a power source line and a ground line that overlap each other, at least one of the power source line and the ground line being the plate-like transmission member, and
the linear transmission members are communication lines, and overlap the ground line on the side opposite to the power source line.

6. The wiring member according to claim 1,
wherein the plurality of plate-like transmission members are in contact with and overlapping each other, and
the plurality of linear transmission members are arranged side by side on one main surface on one of the plurality of plate-like transmission members so as to be located on an outer side of the wiring body.

7. The wiring member according to claim 1,
wherein the plate-like transmission members bend in a front-back direction at the bent portion of the wiring body.

8. The wiring member according to claim 1,
wherein a width of the plate-like transmission member is at least a total of the widths of the plurality of linear transmission members arranged side by side on the main surface of the plate-like transmission member.

9. The wiring member according to claim 1,
wherein the linear transmission members are fixed to a sheet member in a state of being arranged side by side on the sheet member, and
the sheet member is fixed to the wiring body.

10. A wiring member arrangement structure comprising:
the wiring member according to claim 1; and
an arrangement target that includes an arrangement surface on which the wiring member is arranged,
wherein, of the wiring body and the linear transmission members, the wiring body is located on the arrangement surface side.

11. A wiring member arrangement structure comprising:
the wiring member according to claim 1; and
an arrangement target that includes an arrangement surface on which the wiring member is arranged,
wherein, of the wiring body and the linear transmission members, the linear transmission members are located on the arrangement surface side, and
the wiring member arrangement structure further includes a spacer for spacing apart the linear transmission members and the arrangement surface from each other.

12. The wiring member arrangement structure according to claim 11, further comprising
a fixing member for fixing the wiring member to the arrangement target,
wherein the fixing member also functions as the spacer.

13. The wiring member arrangement structure according to claim 10,
wherein the arrangement surface is a surface that has recesses and protrusions in a first direction in a horizontal direction and extends in a vertical direction and a second direction in the horizontal direction, and
the wiring member extends in the second direction in the horizontal direction while bending in the first direction in the horizontal direction in accordance with the recesses and protrusions on the arrangement surface.
